(19) United States
(12) Patent Application Publication
(10) Pub. No.: US 2014/0292474 A1
(43) Pub. Date: Oct. 2, 2014

(54) CHIP RESISTOR

(71) Applicant: SAMSUNG ELECTRO-MECHANICS CO., LTD., Suwon-si (KR)

(72) Inventors: Heung Bok RYU, Suwon-si (KR); Dong Hyun LEE, Suwon-si (KR); Ha Sung HWANG, Suwon-si (KR); Jung Il KIM, Suwon-si (KR); Young Key KIM, Suwon-si (KR)

(73) Assignee: SAMSUNG ELECTRO-MECHANICS CO., LTD., Suwon-si (KR)

(21) Appl. No.: 14/219,798

(22) Filed: Mar. 19, 2014

(30) Foreign Application Priority Data
Mar. 29, 2013 (KR) 10-2013-0034677

(51) Int. Cl. H01C 1/012; H01C 1/14

(52) U.S. Cl. CPC H01C 1/012; H01C 1/14
USPC 338/306

(57) ABSTRACT

Disclosed herein is a chip resistor in which a plurality of resistor bodies are configured in a single chip in a limited space in an electronic product. The chip resistor includes: a substrate; electrodes formed on each side surface of the substrate; and resistor bodies connected to the electrodes and formed on upper and lower surfaces of the substrate, such that a production cost thereof may be significantly reduced.

### CROSS REFERENCE(S) TO RELATED APPLICATIONS

This application claims the benefit under 35 U.S.C. Section 119 of Korean Patent Application Serial No. 10-2013-0034677, entitled “Chip Resistor” filed on Mar. 29, 2013, which is hereby incorporated by reference in its entirety into this application.

### BACKGROUND OF THE INVENTION

1. Technical Field

The present invention relates to a chip resistor, and more particularly, to a chip resistor in which a plurality of resistor bodies are configured in a single chip in a limited space in an electronic product.

2. Description of the Related Art

Generally, a chip resistor means a resistor manufactured in a form of a semiconductor package by mounting a plurality of resistors in one body in order to increase a degree of integration of an electronic product.

The chip resistor as described above is mainly mounted in a semiconductor module. In this case, sizes of a personal computer (PC) and a server have become gradually smaller, whereas there is a limitation in reducing a size of the semiconductor module, for example, a memory module, or the like, mounted in the PC or the server.

Therefore, as the chip resistor mounted in the memory module, an array type chip resistor in which a plurality of resistor bodies are configured integrally with one another in order to increase the degree of integration has been used.

The array type chip resistor is mainly used in order to reduce noise of a signal wave reflected from the semiconductor package in which the memory module is mounted. However, a chip resistor according to the related art may cause various quality problems due to an external environment at the time of being mounted on a printed circuit board.

That is, the chip resistor according to the related art is configured to include a substrate, a resistor body formed on upper surface of the substrate and an external electrode connected to the resistor body and extended from the upper surface of the substrate to a side surface and a lower surface thereof. Here, the external electrode becomes a terminal of a conductor to thereby be used as an electrical connection unit at the time of mounting the chip resistor on the printed circuit board.

However, as a thickness of an electronic product that has been recently released has become very thin and a size of a battery of the electronic product has increased, the chip resistor installed on the PCB should be miniaturized in a form in which it is further miniaturized and complex. However, it is difficult to significantly reduce a size of the chip resistor itself. In addition, even though the size of the chip resistor itself is reduced, a cost required for manufacturing and installing each of a plurality of chip resistors is not reduced.

### RELATED ART DOCUMENT

### Patent Document

(Patent Document 1) Cited Reference: Japanese Patent Laid-Open Publication No. 2008-263094

### SUMMARY OF THE INVENTION

An object of the present invention is to provide a chip resistor capable of reducing an installation area and a manufacturing cost by configuring a plurality of resistor bodies in a single chip in a limited space in an electronic product.

According to an exemplary embodiment of the present invention, there is provided a chip resistor including: a substrate; electrodes formed on each side surface of the substrate; and resistor bodies connected to the electrodes and formed on upper and lower surfaces of the substrate.

A plurality of resistor bodies may be arranged on the upper and lower surfaces of the substrate and be connected to the electrodes through an electrode connector.

The resistor body may have a protective layer stacked thereon and the protective layer may include a leveling electrode stacked thereon so as to be electrically connected to the electrode.

The protective layer may further include a plating layer electrically connected to the leveling electrode and the plating layer may include an insulating layer stacked thereon.

The insulating layer may include a molding layer stacked thereon, thereby making it possible to minimize damage to the insulating layer.

At least one pair of resistor bodies may be provided and be disposed in parallel with each other on the upper and lower surfaces of the substrate and the resistor bodies may be arranged in directions which a position thereof installed on the upper surface of the substrate and a position thereof installed on the lower surface of the substrate intersect with each other.

### BRIEF DESCRIPTION OF THE DRAWINGS

FIGS. 1A and 1B are a plan view and a bottom view illustrating a chip resistor according to an exemplary embodiment of the present invention, respectively;

FIG. 2 is a cross-sectional view illustrating the chip resistor according to the exemplary embodiment of the present invention; and

FIGS. 3A to 3C are views illustrating a chip resistor according to another exemplary embodiment of the present invention.

### DESCRIPTION OF THE PREFERRED EMBODIMENTS

Hereinafter, preferred embodiments of the present invention will be described in detail with reference to the accompanying drawings.

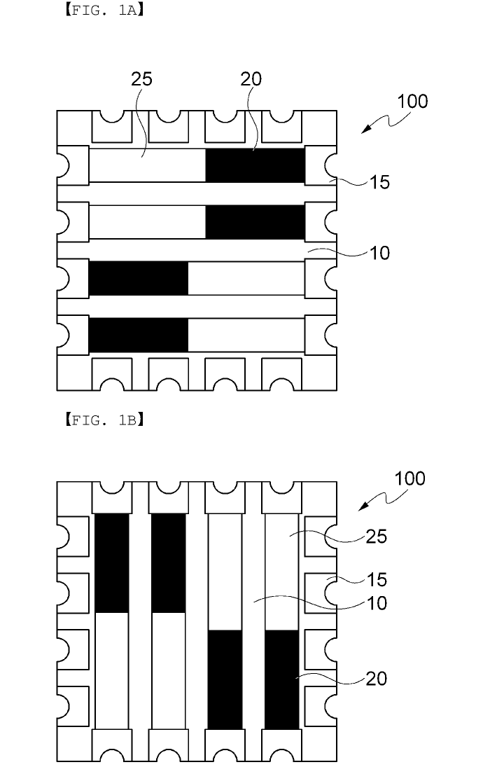

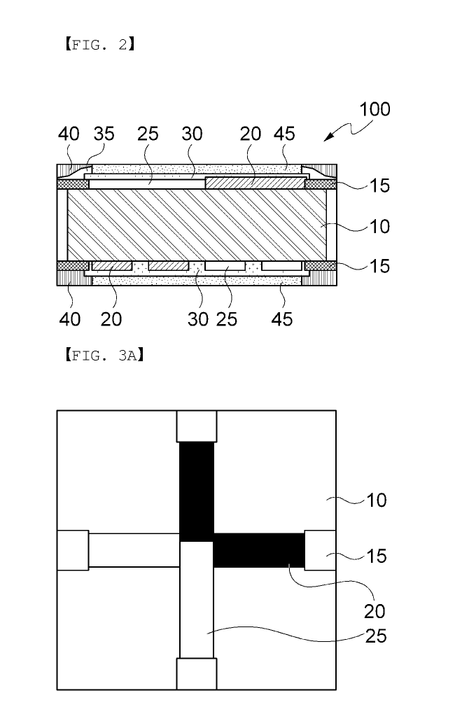

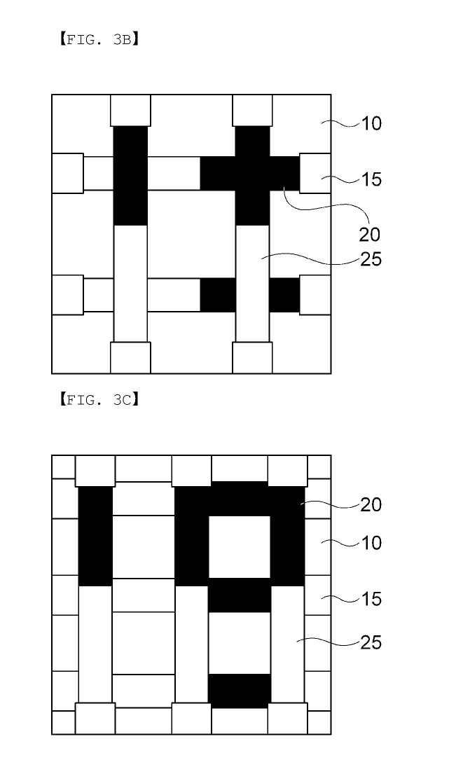

FIGS. 1A and 1B are a plan view and a bottom view illustrating a chip resistor according to an exemplary embodiment of the present invention, respectively; FIG. 2 is a cross-sectional view illustrating the chip resistor according to the exemplary embodiment of the present invention; and FIGS. 3A to 3C are views illustrating a chip resistor according to another exemplary embodiment of the present invention.

As shown in FIGS. 1A to 2, the chip resistor 100 according to the exemplary embodiment of the present invention is configured to include a substrate 10 having electrodes 15 formed along a circumferential surface thereof and resistor bodies 20 connected to the electrodes 15 and disposed on upper and lower surfaces of the substrate 10, respectively.

The substrate 10 may have a cubic plate shape in which horizontal and vertical lengths thereof are the same as each other. Alternatively, in other designs, the substrate 10 may have a rectangular parallelepiped shape in which any one of the horizontal and vertical lengths thereof is longer than the other.

The electrodes 15 may be formed at the circumferential surface of the substrate 10, that is, edge portions of each side surface of the substrate 10. The electrode 15 may be configured in a form in which it has an electrode groove or in a form in which it does not have the electrode groove.

In addition, the substrate 10 is made of a material having excellent thermal conductivity to serve as a heat diffusion path of heat to diffuse heat generated from the resistor bodies 20 to the outside at the time of mounting the chip resistor 100 on a surface thereof.

The substrate 10 may have the resistor bodies 20 disposed thereon, more specifically, on the upper and lower surfaces thereof, respectively.

The resistor bodies 20 may be stacked in a form in which they are printed on the surfaces of the substrate 10, and a plurality of resistor bodies 20 may be printed on the upper surface and lower surface of the substrate 10. When the number of printed resistor bodies 20 is increased, the resistor bodies 20 may be printed so as to be positioned at diagonal portions, respectively.

That is, as shown in FIGS. 1A and 1B, for example, when four resistor bodies 20 are printed on the upper and lower surfaces of the substrate 10, they may be printed in pair at the diagonal portions.

In this case, the resistor bodies 20 printed on the upper and lower surfaces of the substrate 10 may be printed in a horizontal direction and a vertical direction and be printed at different positions.

The reason why the resistor bodies 20 are printed at the different positions on the upper and lower surfaces of the substrate 10 is to improve a heat generating rate of the resistor bodies 20 while keeping a thickness of the chip resistor 100 to be constant.

When the resistor bodies 20 are printed on the upper and lower surfaces of the substrate 10, both sides or any one portion of the resistor bodies 20 is directly connected to the electrode 15, and a front end portion of the resistor body 20 which is not directly connected to the electrode 15 is connected to the electrode 15 through an electrode connector 25.

The electrode connector 25 may also be each connected to both sides of the resistor body 20 according to a position of the resistor body 20. For example, when the resistor body 20 is printed at a central portion of the substrate 10, the electrode connector 25 may be connected to both sides of the resistor body 20 to thereby be connected to the electrode 15. To the contrary, when only one end portion of the resistor body 20 is directly connected to the electrode 15, the electrode connector 25 may be configured so as to be connected to the electrode 15 at the other end portion of the resistor body 20 which is not connected to the electrode 15.

In addition, the resistor body 20 printed on the upper and lower surfaces of the substrate 10 may be printed in different directions and at different positions. In this case, the resistor body 20 printed on the upper surface of the substrate 10 is connected to the substrate 10 in the horizontal direction. To the contrary, the resistor body 20 printed on the lower surface of the substrate 10 is connected to the substrate 10 in the vertical direction.

The resistor body 20 each printed on the upper and lower surfaces of the substrate 10 as described above may have a protective layer 30 stacked thereon.

The protective layer 30, which is to protect the resistor body 20 from external impact, may be made of a material such as silicon (SiO₂) or glass.

In addition, the protective layer 30 may have a leveling electrode 35 stacked thereon so as to be electrically connected to the electrode 15.

The leveling electrode 35 may be formed on an edge part of the protective layer 30 and serve to expand a reduced effective area of the electrode 15 to enable a stable contact of the electrode 15.

In addition, the leveling electrode 35 is formed at a predetermined height on the electrode 15 and serves to make a height of the electrode 15 higher than that of an insulating layer 45 as well as the resistor body 20 and the protective layer 30 printed on the substrate 10.

That is, the leveling electrode 35 is to make the height of electrode substantially equal to that of the resistor body 20 and the protective layer 30 formed at a central portion of the substrate 10 and contacts the effective area of the electrode 15 reduced at the time of forming the resistor body 20 and the protective layer 30 to expand the area of the electrode 15, thereby securing stability of the electrode 15 and allowing a plating layer 40 to be easily formed.

The leveling electrode 35 has the plating layer 40 formed thereon in order to form a final external electrode. The plating layer 40 may be formed by sequentially performing nickel (Ni) plating and tin (Sn) plating and be formed by electrolytic plating and electroless plating.

In this case, the nickel plating layer is a plating layer for protecting the leveling electrode 15 at the time of soldering, and the tin plating layer is formed in order to facilitate the soldering at the time of soldering.

Furthermore, the chip resistor 100 according to the exemplary embodiment of the present invention further includes the insulating layer 45 covering the entire protective layer 30 at the time of forming the external electrode by the plating layer 40. The insulating layer 45 may be made of a material such as glass or polymer, similar to the protective layer 30 and finally serve to protect the resistor body 20.

In addition, the insulating layer 45 may completely block the resistor body 20 from being exposed to the outside to protect the resistor body 20 from the external impact and covers the entire surface of the protective layer 30 and a portion of the leveling electrode 35, which is an additional electrode, to prevent a plating solution from being penetrated into the resistor body 20 at the time of forming the plating layer 40 for forming the external electrode.

Here, the plating layers 40 formed at both sides of the insulating layer 45 are formed at a height higher than that of the central portion of the insulating layer 45.

The reason why the plating layers 40 are formed at a high height at both sides of the insulating layer 45 is to allow the chip resistor 100 according to the exemplary embodiment of the present invention to be stably mounted on a main substrate (PCB), more specifically, to prevent generation of a tombstone defect that the chip resistor 100 is mounted on the main substrate in the state in which it is inclined to one side due to a convex central portion of the insulating layer 45 at the time of soldering the chip resistor 100 in the case in which the convex central portion is formed to be higher than the plating layer 40.

In addition, although not shown, a molding layer is stacked on the insulating layer 45, thereby making it possible to minimize damage to the insulating layer 45.

The molding layer, which is to additionally supplement a function of the insulating layer 45, may be configured to completely block the plating solution from penetrating into the resistor body 20 at the time of forming the plating layer 40.

Meanwhile, FIGS. 3A to 3C illustrate forms, the number, and the like, of resistor body 20 arranged on the upper and lower surfaces of the substrate 10 among the components of the chip resistor according to the exemplary embodiment of the present invention.

As shown, the resistor bodies 20 may be arranged on the upper and lower surfaces of the substrate 10 in directions in which they are perpendicular to each other. That is, in FIG. 3A, one resistor body 20 may be printed on each of the upper and lower surfaces of the substrate 10 and be configured so that one end thereof is directly connected to the electrode 15 and the other end thereof which is not connected to the electrode 15 is connected to the electrode 15 through the electrode connector 25.

In addition, FIG. 3B illustrates the state in which two resistor bodies 20 are printed on each of the upper and lower surfaces of the substrate 10. In this case, both of one ends of the two resistor bodies 20 are directly connected to the electrodes 15, and the other ends thereof are connected to the electrodes 15 through the electrode connectors 25.

Accordingly, the resistor bodies 20 printed on the upper and lower surfaces of the substrate 10 are printed in directions in which they are perpendicular to each other.

FIG. 3C illustrates the case in which three resistor bodies 20 are printed on each of the upper and lower surfaces of the substrate 10. Similar to FIG. 3B, in FIG. 3C, all of one ends of the three resistor bodies 20 are directly connected to the electrodes 15 and the other ends thereof are connected to the electrodes 15 through the electrode connectors 25.

As described above, the directions in which the resistor bodies 20 are printed on the upper and lower surfaces of the substrate 10 are perpendicular to or intersect with each other. In addition, even though the number of resistor bodies 20 is increased, only a difference in an interval between the resistor bodies 20 is generated, and the directions in which the resistor bodies 20 are printed are the same as each other.

In other words, in the case of the resistor bodies 20 printed on the upper and lower surfaces of the substrate 10, the resistor bodies 20 are arranged in directions in which they are perpendicular to each other or intersect with each other, and in the case of the resistor bodies 20 printed on the upper surface or the lower surface of the substrate 10, that is, in the case of the resistor bodies 20 on the same plane, the respective resistor bodies 20 are maintained in the state in which they are disposed in parallel with each other regardless of the number thereof.

Therefore, in the chip resistor 100 according to the exemplary embodiment of the present invention, the plurality of resistors bodies 20 are configured on the upper and lower surfaces of the substrate 10, respectively, in the single chip, such that the entire size of the chip resistor 100 itself is increased, but the number of installed chip resistors and a cost required for installing the chip resistors may be significantly reduced.

With the chip resistor according to the exemplary embodiments of the present invention, the plurality of resistor bodies are configured in a single chip in a limited space in the electronic product, thereby making it possible to reduce an installation area and a manufacturing cost.

Although the chip resistor according to the exemplary embodiment of the present invention has been described, the present invention is not limited thereto, and those skilled in the art will appreciate that application and various modifications are possible.

What is claimed is:

1. A chip resistor comprising:
a substrate;
electrodes formed on each side surface of the substrate; and
resistor bodies connected to the electrodes and formed on upper and lower surfaces of the substrate.

2. The chip resistor according to claim 1, wherein a plurality of resistor bodies are arranged on the upper and lower surfaces of the substrate.

3. The chip resistor according to claim 1, wherein the resistor body is connected to the electrode through an electrode connector.

4. The chip resistor according to claim 1, wherein the resistor body has a protective layer stacked thereon.

5. The chip resistor according to claim 4, wherein the protective layer includes a leveling electrode stacked thereon so as to be electrically connected to the electrode.

6. The chip resistor according to claim 5, wherein the protective layer further includes a plating layer electrically connected to the leveling electrode.

7. The chip resistor according to claim 6, wherein the plating layer includes an insulating layer stacked thereon.

8. The chip resistor according to claim 7, wherein the insulating layer includes a molding layer stacked thereon.

9. The chip resistor according to claim 1, wherein at least one pair of resistor bodies are provided and are disposed in parallel with each other on the upper and lower surfaces of the substrate.

10. The chip resistor according to claim 1, wherein the resistor bodies are arranged in directions which a position thereof installed on the upper surface of the substrate and a position thereof installed on the lower surface of the substrate intersect with each other.
